(19) United States
(12) Patent Application Publication
(10) Pub. No.: US 2023/0052968 A1
(43) Pub. Date: Feb. 16, 2023

(54) METHODS AND SYSTEMS FOR DETERMINING VERIFICATION INFORMATION RELATED TO VIRTUAL CARDS

(71) Applicant: Capital One Services, LLC, McLean, VA (US)

(72) Inventor: Michelle OLENOSKI, Washington, DC (US)

(73) Assignee: Capital One Services, LLC, McLean, VA (US)

(21) Appl. No.: 17/818,543

(22) Filed: Aug. 9, 2022

Related U.S. Application Data
(60) Provisional application No. 63/260,147, filed on Aug. 11, 2021.

(51) Int. Cl. G06Q 20/34; G06Q 20/40; G06Q 20/24; G06F 3/04815; G06F 3/01; G06T 19/00

(52) U.S. Cl. CPC G06Q 20/351; G06Q 20/4018; G06Q 20/24; G06F 3/04815; G06F 3/017; G06Q 20/40145; G06T 19/006

(57) ABSTRACT

Disclosed are systems and methods for utilizing virtual reality for virtual cards. For example, a method of determining verification information may include: obtaining an image of a merchant site of a merchant captured by at least one camera of a first computing device, wherein the merchant site is displayed on a display of a second computing device; identifying one or more characters in the captured image; determining that the identified one or more characters indicate a virtual credit card number associated with a user; determining a card verification value associated with the virtual credit card number and an expiration date associated with the virtual credit card number; and displaying information regarding the determined virtual credit card number on a display of the first computing device.

### CROSS-REFERENCE TO RELATED APPLICATIONS

This application claims priority to U.S. Provisional Application No. 63/260,147, filed on Aug. 11, 2021, the entirety of which is incorporated by reference herein.

### TECHNICAL FIELD

Various embodiments of the present disclosure relate generally to methods and systems for determining verification information, and more particularly, to determining verification information related to virtual cards.

### BACKGROUND

A customer may desire the ability to make payments from a credit card account or other financial account without exposing the account number. Tokens, such as virtual card numbers, may be used to represent the account without exposing the account number. However, due to the use of various different tokens for various merchants, it is becoming increasingly cumbersome for a user to retrieve verification information associated with a token during transactions initiated with virtual cards. In some instances, this inconvenience may deter the user from completing the transaction. Therefore, there is a need for systems and methods for determining verification information related to tokens, such as virtual cards. Such verification information may include, e.g., expiration dates and/or Card Verification Value (CVV) codes associated with virtual cards.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for determining verification information, and more particularly, to determining verification information related to tokens, such as virtual cards.

In one aspect, a method is disclosed of determining verification information. The method may include: obtaining, via one or more processors, an image of a merchant site of a merchant captured by at least one camera of a first computing device, wherein the merchant site is displayed on a display of a second computing device; identifying, via the one or more processors, one or more characters in the captured image; determining, via the one or more processors, that the identified one or more characters indicate a virtual credit card number associated with a user, wherein the virtual credit card number comprises a tokenized credit card payment account number (PAN); determining, via the one or more processors, a card verification value associated with the virtual credit card number and an expiration date associated with the virtual credit card number upon determining that the captured image includes one or more characters indicative of the virtual credit card number; and displaying, via the one or more processors, any one or a combination of at least a portion of the determined virtual credit card number, the determined card verification value associated with the virtual credit card number, and the determined expiration date associated with the virtual credit card number on a display of the first computing device.

In another aspect, there is provided a first computing device for determining verification information. The first computing device may include a memory, at least one camera, a display, and one or more processors. The one or more processors may be configured to: obtain an image of a merchant site of a merchant captured by the at least one camera, wherein the merchant site is displayed on a display of a second computing device; identify one or more characters in the captured image; determine that the identified one or more characters indicate a virtual credit card number associated with a user, wherein the virtual credit card number comprises a tokenized credit card payment account number (PAN); determine a card verification value associated with the virtual credit card number and an expiration date associated with the virtual credit card number upon determining that the captured image includes one or more characters indicative of the virtual credit card number; and display any one or a combination of at least a portion of the determined virtual credit card number, the determined card verification value associated with the virtual credit card number, and the determined expiration date associated with the virtual credit card number on the display.

In another aspect, there is provided a method of determining verification information. The method may include: determining, via one or more processors, a merchant site of a merchant based on: (1) an image of the merchant site captured by at least one camera of a first computing device and/or (2) information transmitted by a second computing device including an indication of the merchant site of the merchant; authenticating, via the one or more processors, a user accessing the determined merchant site via the second computing device; determining, via the one or more processors, a virtual credit card number associated with the user and the determined merchant site, wherein the virtual credit card number comprises a tokenized credit card payment account number (PAN); determining, via the one or more processors, a card verification value associated with the determined virtual credit card number and an expiration date associated with the determined virtual credit card number; and displaying, via the one or more processors, any one or a combination of at least a portion of the determined virtual credit card number, the determined card verification value associated with the virtual credit card number, and the determined expiration date associated with the virtual credit card number on a display of the first computing device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method for payment authentication, according to one or more embodiments.

FIG. 3 depicts a flowchart of an exemplary method of determining verification information, according to one or more embodiments.

FIG. 4 depicts another flowchart of an exemplary method of determining verification information, according to one or more embodiments.

FIG. 5 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” and other variations thereof are intended to cover a non-exclusive inclusion such that a process, method, or product that comprises/includes a list of elements does not necessarily encompass only those elements, but may encompass other elements not expressly listed or inherent to such a process, method, article, or apparatus. Relative terms, such as, “substantially” and “generally,” are used to indicate a possible variation of ±10% of a stated or understood value.

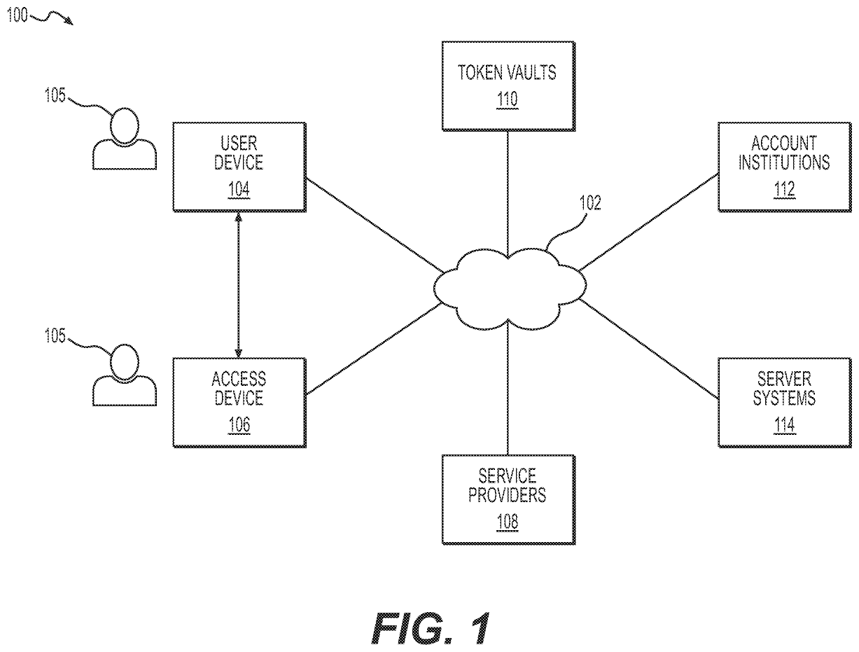

FIG. 1 illustrates an exemplary system 100, which may encompass aspects of the embodiments disclosed herein, and/or in which or by which steps of methods disclosed herein may be performed. System 100 may include a network 102, which may connect a user device 104, an access device 106, service providers 108, token vaults 110, account institutions 112, and server systems 114.

System 100 may include computer hardware, computer software, and/or combinations of both associated with each aspect of system 100. Aspects of system 100 may be located in similar or disparate locations. In some instances, for example, user device 104, access device 106, service providers 108, token vaults 110, account institutions 112, and server systems 114 may each be in separate physical locations (e.g., on separate computer systems, in separate databases, and/or in separate geographic locations). In some instances, for example, multiple user devices 104, multiple access devices 106, multiple service providers 108, multiple token vaults 110, multiple account institutions 112, and/or multiple server systems 114 may be located in separate geographical locations. In further instances, two or more of the aspects of system 100 may be located in the same physical location, e.g., on the same computer, in the same database, or in the same geographic location. For example, an account institution 112 may house a server system 114 and a token vault 110 at a single geographic location. The account institution 112 may own and/or operate the server system 114 in accordance with the embodiments disclosed herein.

Aspects and components of system 100 may be connected by wired or wireless connections. Some such connections are represented by the straight lines connecting some of the aspects of system 100 in FIG. 1; however, it is contemplated that additional or different wired or wireless connections may exist between aspects of system 100. Wired or wireless connections between aspects of system 100 may include, for example, connections within a single machine, or wired or wireless connections over a local area network or a wide area network (e.g., the Internet). Furthermore, while aspects of system 100 are shown in FIG. 1, it is contemplated that system 100 may include more components, fewer components, and/or alternate or additional configurations of the depicted components.

Network 102 may be any suitable wired or wireless network, or combination of wired or wireless networks. For example, in some embodiments, network 102 may include a local area network (LAN), wide area network (WAN), a public switch telephone network (PSTN), and/or the Internet. Generally, network 102 may serve to electronically connect two or more components of system 100, or two or more computers, electronic terminals, databases, servers, devices, user interfaces, or other electronic aspects of one or more components of system 100. Any part of system 100 may be connected directly to another (e.g., via a wired or wireless connection) over network 102, or may be connected indirectly via one or more intermediary servers, computers, LANs, WANs, routers, etc. to another part or parts of system 100. In some embodiments, network 102 may be simply a plurality of electronic connections between devices, servers, and the like.

In some embodiments, two or more components of system 100 may share a physical location. For example, server system 114 may be located within, e.g., an account institution 112. In some embodiments, each account institution 112 and/or service provider 108 may include a server system 114. A user device 104 and an access device 106 may be located in the same geographic location (e.g., in the same room, at the same address, or in the same city, state, province, or country).

User device 104 may be a device suitable for connecting to other components of system 100 via network 102. A user 105 of user device 104 may be a customer of, e.g., one or more of account institutions 112 and/or service providers 108. In some embodiments, user 105 of user device 104 may be enrolled in one or more programs, rosters, account types, services, etc. in an account institution 112 or a service provider 108. In some embodiments, user 105 of user device 104 may hold a financial account at an account institution 112. In some embodiments, user 105 of user device 104 may have multiple accounts at one or more of account institutions 112 or service providers 108. In some embodiments, user device 104 may communicate with one or more access devices 106 through a local area network or direct connection, such as, via a Bluetooth connection. In some embodiments, user device 104 may include any type of computing device, such as a mobile and/or desktop computing device. For example, user device 104 may be a wearable device, such as, for example, smart watch wearable device, a smart eyewear device, augmented reality device, and/or virtual reality device.

Access device 106 may be a device suitable for connecting to other components of system 100 via network 102. A user of access device 106 may be a customer of, e.g., one or more of account institutions 112 and/or service providers 108. In some embodiments, user of access device 106 may be user 105 of user device 104. For the purpose of explanation, user of both user device 104 and access device 106 is referred to as user 105. It is understood, however, that there may be separate users for user device 104 and access device 106 in other embodiments. In some embodiments, user 105 of access device 106 may be enrolled in one or more programs, rosters, account types, services, etc. in an account institution 112 or a service provider 108. In some embodiments, user 105 of access device 106 may hold a financial account at an account institution 112. In some embodiments, user 105 of access device 106 may have multiple accounts at one or more of account institutions 112 or service providers 108. In some embodiments, access device 106 may include any type of computing device, such as a mobile and/or desktop computing device.

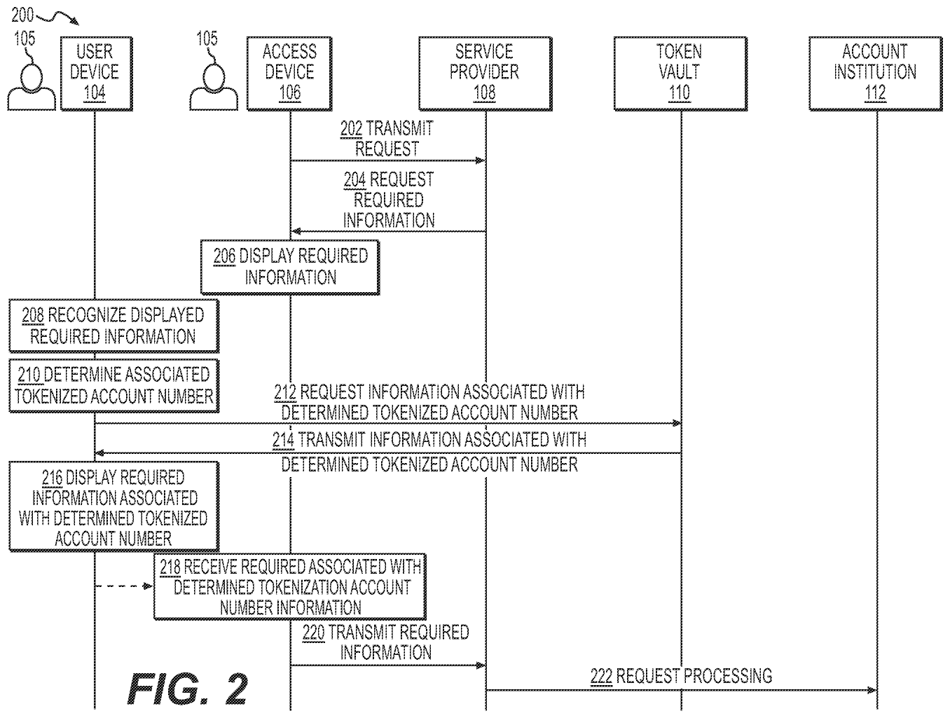

In some embodiments, user 105 may initiate a transaction using a token with a service provider 108 as will be described in further detail below. In such embodiments, user 105 may utilize user device 104 and access device 106 to perform the transaction. Exemplary embodiments of such transactions will be described in further detail below with reference to FIG. 2.

Service providers 108 (also referred to as merchants in some instances) may include any institutions, businesses, individuals, or organizations providing services to, e.g., users within system 100 (e.g., user 105 of user device 104 and/or access device 106). Examples of service providers 108 may include medical service providers (e.g., hospitals, doctors, surgical centers, diagnostics laboratories, emergency responders, etc.). Further examples of service providers 108 may include merchants such as automobile companies, automobile dealerships, clothing companies, restaurants, travel service providers, video and/or audio subscription service providers, etc. Some other examples of service providers 108 may include educational institutions, charities, etc. In some embodiments, service providers 108 may require payments from a user in exchange for services performed. In some embodiments, service providers 108 may include a computer system operated by a merchant. The computer system may, for example, execute a server program that services an electronic commerce (e-commerce) application from which user 105 may purchase a product and/or service. Such a purchase may involve an online payment using a token as described in this disclosure. In some embodiments, a service provider 108 may be associated with an account institution 112, such that users (e.g., user 105 of user device 104 and/or access device 106) may hold accounts (e.g., loan accounts, bank accounts, debit accounts, etc.) for sending or receiving payments to or from service provider 112. In some embodiments, account institutions 112 may include one or more servers or server systems storing the details of services rendered to such users. Such servers or server systems may be connected to other aspects of system 100 via one or more connections, such as via network 102.

Account institutions 112 may include any entities or organizations offering accounts to users, e.g., user 105 of user device 104 and/or access device 106. An account may be any type of account directly or indirectly related to a user's finances. Examples include bank accounts, investment accounts, loan accounts (e.g., for auto loans, student loans, mortgages, or other loans), credit accounts, or accounts for managing regular payments (e.g., student or tuition accounts, leases, etc.). In some embodiments, account institutions 112 may include one or more payment authentication systems. The payment authentication systems may be configured to generate and store tokens representing part or all of a user's account information and/or credentials needed to use an account. Accordingly, the payment authentication systems may also be referred to as token servers 110 (or alternately, token service provider computer systems). In some embodiments, account institutions 112 may include (e.g., own, operate, manage, and/or be associated with) one or more servers or server systems storing the details of accounts associated with users. Such servers or server systems may be connected to other aspects of system 100 via one or more connections, such as via network 102.

In some embodiments, tokens generated by the payment authentication systems may be stored at a token vault 110, which may include any appropriate secure data store. In some embodiments, token vault 110 may include a plurality of datasets respectively pertaining to different primary account numbers (PANs). In some embodiments, a first dataset may pertain to a first PAN, which may be the PAN of the aforementioned financial account of, or accessible to, user 105. Token vault 110 may include further datasets which may pertain to other PANs, which may include other PANs of user 105 and/or PANs of other users.

The first dataset for the first PAN may include various tokens (e.g., token T1, token T2, token T3, and token T4). Each of the tokens in the first dataset may be a representation of the first PAN. When a token represents the first PAN, a payment made using the token (e.g., where a user identifies the token) may result in payment from a financial account associated with the first PAN. A token may be, for example, a virtual card number that can be used in the manner of a credit card on an electronic commerce application serviced by service provider 108. A virtual card number may have characteristics of a credit card number, such as a length of 13 to 19 digits (which may include, for example, issuer identifier numbers and/or numbers corresponding to financial institutions). In the context of the current disclosure, a virtual card number may be referred to as a tokenized card (e.g., credit card or debit card) PAN. In some embodiments, each virtual card number may be associated with a specific card verification value (CVV) code and expiration date. Accordingly, a token may include a virtual card number, an associated CVV code, and an associated expiration date according to some embodiments. Each of the tokens in the first dataset may be associated with a service provider 108 at which use of the corresponding token is permitted (e.g., for an in-person or online transaction with the service provider 108). Such a service provider 108, at which use of the corresponding token is permitted, may also be referred to as an authorized service provider. When a token is associated with one or more authorized service provider, the token may be unusable for payments to any service provider other than the one or more authorized service provider. Service providers may each have a service provider identifier, which may be, for example, an identification number unique to the service provider, used in payment processing.

Different tokens may be associated with a single service provider, or with multiple different service providers. Associations between a token and a service provider may be stored in any suitable manner. For example, the first dataset for a PAN may be a data table in which each row specifies a token representing the respective PAN and a service provider identifier corresponding to a service provider. In some embodiments, the association between a token and a service provider may be stored in user device 104 and/or access device 106. For example, a token, such as a virtual card number, and an associated service provider identifier may be stored in user device 104 and/or access device 106. As another example, a virtual card number and an associated service provider identifier may be stored in, e.g., a server system 114 (described in further detail below). In some embodiments, data associated with the virtual card number (such as a CVV code and/or an expiration date) may be stored only at token vault 110, so that such data may be used as verification information for any transactions initiated by user 105 using the virtual card number, as will be described in further detail below.

Server system 114 may comprise one or more computers, and may be configured to house databases or other electronic storage systems. Further, server system 114 may be configured to store and/or execute one or more functions, algorithms, or manipulations of data housed within it or transferred to it. In some embodiments, server system 114 may receive and send data via, e.g., network 102, and may store, manipulate, or perform calculations using such data. Server system 114 may also be configured or authorized to access, send, retrieve, or manipulate data from other aspects of system 100, such as from account institutions 112 or service providers 108. For example, in some embodiments, server system 114 may be authorized to access secure data pertaining to one or more digital accounts associated with one or more account institutions 112. In some embodiments, server system 114 may house one or more machine learning algorithms and may execute such algorithms according to methods of the present disclosure. In some embodiments, server system 114 may include one or more modules, models, or engines, which may each be software components stored in server system 114. Server system 114 may be configured to utilize one or more modules, models, or engines when performing various methods described in this disclosure.

In some examples, server system 114 may include, or be a part of, a cloud computing platform with scalable resources for computation and/or data storage, and may run one or more applications on the cloud computing platform to perform various computer-implemented methods described in this disclosure. In some embodiments, some of the one or more modules, models, or engines included in server system 114 may be combined to form fewer modules, models, or engines. In some embodiments, some of the one or more modules, models, or engines may be separated into separate, more numerous modules, models, or engines. In some embodiments, some of the one or more modules, models, or engines may be removed while others may be added. While one server system 114 is depicted in FIG. 1, it is contemplated that, in some aspects, multiple server systems 114 may be a part of systems of the present disclosure and/or may execute methods of the present disclosure in concert.

FIG. 2 depicts a flowchart of an exemplary method 200 for payment authentication, according to one or more embodiments.

As shown in FIG. 2, the method 200 may begin with step 202 in which user 105 may transmit a transaction request to a service provider 108 using an access device 106. For example, user 105 may use access device 106 to request purchase of a product and/or service on an e-commerce application serviced by service provider 108. In some embodiments, the requested transaction may involve an online payment using a token as described herein. For example, the requested transaction may involve payment via a virtual card number that may be used in the manner of a credit card on the e-commerce application serviced by service provider 108.

In step 204, service provider 108 may request required payment information for the transaction upon receipt of the transaction request. In some embodiments, the required payment information may include the virtual card number that may be used for the requested transaction. In such embodiments, the required payment information may further include verification information, e.g., expiration date, CVV code, and/or other code or data associated with the virtual card number.

In step 206, access device 106 may receive the request for the required payment information from service provider 108 and display the required payment information to user 105. In some embodiments, the required payment information may be displayed on access device 106. For example, the required payment information may be displayed to user 105 on a display of a mobile and/or desktop computing device. In some embodiments, a user device 104 may be connected to access device 106 through a local area network or direct connection, such as via a Bluetooth connection. Accordingly, the required payment information may also be displayed on user device 104 according to some embodiments. The required payment information display may include one or more prompts, e.g., blank spaces, for user 105 to provide the requested information. For example, the display may include blank spaces labeled credit card information, CVV code, and expiration date to prompt user 105 to provide the requested information.

In some embodiments, access device 106 may be configured to determine service provider 108 and/or an identifier associated with service provider 108. In some embodiments, a server system 114 may be configured to determine service provider 108 and/or the identifier associated with service provider 108. In such embodiments, server system 114 may transmit information to access device 106 including the determined service provider 108 and/or identifier associated with service provider 108. For example, the received request for required payment information may include the service provider identifier. As another example, access device 106 may receive the service provider identifier from user 105 based on the transmitted transaction request in step 202. As described above with reference to FIG. 1, an association between a token and a service provider may be stored in the access device 106. In some embodiments, the association between the token and the service provider may be stored in server 114 and/or token vault 110. In such embodiments, access device 106 may retrieve the stored association between the token and the service provider as needed. For example, a plurality of virtual card numbers associated with user 105 and corresponding service provider identifiers may be stored at access device 106, server 114 and/or token vault 110. The determined service provider identifier may be used to determine the associated virtual card number. In some embodiments, at least a portion of the determined virtual card number may be displayed on access device 106 to user 105 in addition to the one or more prompts for the required information. For example, a portion of the determined virtual card number may be displayed to user 105 in addition to blank spaces labeled “CVV” and “expiration date” to prompt user 105 to provide the relevant verification information associated with the determined virtual card number.

In step 208, user device 104 may recognize the payment processing information displayed on access device 106. In some embodiments, a server system 114 may provide recognition capabilities for user device 104. For example, user device 104 may establish a connection with server system 114 which may allow user device 104 to utilize recognition capabilities provided by server system 114 in order to recognize the payment processing information displayed on access device 106. In some embodiments, user device 104 may be configured with recognition capabilities such that user device 104 may recognize payment processing information locally. In some embodiments, user device 104 may utilize Optical Character Recognition (OCR) to recognize the payment processing information displayed on access device 106. For example, user device 104 may be a virtual reality (VR)/augmented reality (AR) device, such as a smart eyewear device, including a camera. The VR/AR device may be configured to use the camera to obtain images of the payment processing information displayed on access device 106. The VR/AR device may then utilize OCR to recognize the payment processing information displayed on access device 106. For example, the VR/AR device may recognize the one or more prompts, e.g., labeled blank spaces, for user 105 to provide the requested information, e.g., payment card information, CVV code, and/or expiration date, displayed on access device 106. In some embodiments, the VR/AR device may be configured to detect text such as “Enter Card Number Here” and the like. In some embodiments, the VR/AR device may be configured to recognize a URL displayed on access device 106 and, based on the URL, may identify the requested information. As described above, a portion of the determined virtual card number may be displayed (in step 206) to user 105 in addition to blank spaces labeled “CVV” and “expiration date” to prompt user 105 to provide the verification information associated with the determined virtual card number. In such instances, the VR/AR device may recognize the displayed portion of the virtual card number and determine the virtual card number based on the recognized portion, as will be described in further detail below with reference to step 210. In some embodiments, the VR/AR device may be configured to recognize a logo associated with a payment card service, such as “VISA” or “MasterCard,” that is displayed on access device 106. In some embodiments, user device 104 may receive a message from access device 106 alerting user device 104 that payment processing information is currently being displayed on access device 106. In some embodiments, user device 104 may be configured to detect an audible command from the user that is indicative of the requested information.

In step 210, user device 104 may be configured to determine the virtual card associated with the displayed payment processing information. In some embodiments, user device 104 may be configured to identify service provider 108 that is requesting the required payment information. For example, user device 104 may utilize OCR, image recognition, or the like to identify service provider 108 associated with the displayed payment processing information. As another example, user device 104 may receive a service provider identifier associated with service provider 108 from access device 106. As described above with reference to FIG. 1, an association between a token and a service provider may be stored in user device 104. For example, a plurality of virtual card numbers associated with user 105 and corresponding service provider identifiers may be stored in user device 104. Accordingly, user device 104 may determine the virtual card number associated with the determined service provider identifier. In some embodiments, user device 104 may determine the virtual card number based on a recognized portion of the virtual card number displayed (in step 206) on access device 106. For example, user device 104 may recognize a portion of the displayed virtual card number and determine the rest of the virtual card number based on the stored plurality of virtual card numbers and the associated service provider identifiers. In some embodiments, user device 104 may determine the virtual card number based on the recognized portion of the virtual card number and/or the determined service provider identifier. In some embodiments, user device 104 may determine that no virtual card number is associated with service provider 108. In some embodiments, step 210 may be skipped and the method may proceed to step 212.

In step 212, user device 104 may request information associated with the determined virtual card number. In situations in which user device 104 determines that no virtual card number is associated with service provider 108 or in which user device 104 skips step 210, user device may simply request a virtual card number. In some embodiments, the requested information may be verification information, e.g., expiration date and CVV code, associated with the determined virtual card number. In some embodiments, user device 104 may transmit the request to token vault 110. In some embodiments, an account institution 112 may include token vault 110. In such embodiments, user device 104 may transmit the request to account institution 112. In some embodiments, user 105 may be required to perform an authentication process via user device 104 prior to transmitting the request for information associated with the determined virtual card number. In some embodiments, the authentication process may include a biometric authentication performed through fingerprint sensing, facial recognition, iris scanning, or the like. Accordingly, the request for information associated with the determined virtual card number may be transmitted based on a successful performance of the authentication process. It is understood that the authentication process may be performed utilizing any appropriate authentication method with reference to user device 104. For example, the authentication method may include a two factor authentication process utilizing user device 104 and any other appropriate device (e.g., access device 106) accessible to user 105.

In step 214, user device 104 may receive the requested information associated with the determined virtual card number. For example, the received information may include the determined virtual card number and associated verification information, e.g., expiration date and/or CVV code.

In step 216, the information received in step 214 may be displayed to user 105 on user device 104. For example, user device 104 may be a VR/AR device, such as a smart eyewear device, including a camera and a display. The VR/AR device may display the received information to user 105 using the display. In some embodiments, the VR/AR device may be configured to use the camera to obtain images of the payment processing information displayed on access device 106 and display the obtained images to user 105. In such embodiments, the VR/AR device may be configured to display the received information, e.g., the virtual card number and associated verification information, in the obtained images to user 105. The VR/AR device may overlay the received information on the obtained images in corresponding positions. For example, the virtual card number may be displayed in a position on the obtained images corresponding to a payment card number. As another example, the expiration date may be displayed in a position on the obtained images corresponding to an expiration date associated with the payment card number. As yet another example, the CVV code may be displayed in a position on the obtained images corresponding to a CVV code associated with the payment card number. It is understood that the VR/AR device may overlay the received information in various formats on any position on the obtained images in alternative embodiments.

In step 218, access device 106 may receive the required payment information, such as the virtual card number, the associated expiration date, and/or the CVV code. In some embodiments, user 105 may directly input the required payment information on access device 106 based on the information displayed to user 105 in step 216. In some embodiments, while user 105 is inputting the required payment information on access device 106, user device 104 may be configured to detect and display errors in the entered information. For example, if user 105 inputs the PAN or CVV code incorrectly, user device 104 may be configured to issue an alert to user 105, such as a visual or audible alert. In some embodiments, access device 106 may receive the required payment information from user device 104. For example, user device 104 may be a VR/AR device configured to relay input received from user 105 to access device 106. In some embodiments, the VR/AR device may be configured to detect a user 105 gesture, such as, for example, a nod of the head or a blink of an eye. In such embodiments, the VR/AR device may be configured to transmit the virtual card information, e.g., the virtual card number, the associated expiration date, and/or the CVV code, displayed in step 216 to access device 106 as a result of detecting the user 105 gesture.

In step 220, access device 106 may transmit the required payment information to the service provider 108. Accordingly, in step 222, service provider 108 may request payment processing to account institution 112 once the required payment information has been received.

In some embodiments, in lieu of access device 106 transmitting the required payment information to the service provider 108, user device 104 may transmit the required payment information to the service provider 108 directly. For example, a browser or a browser extension on user device 104 may be used to transmit the required payment information directly from user device 104 to service provider 108. In such embodiments, it may be unnecessary for the user 105 to provide the required payment information to access device 106 as described with reference to step 218.

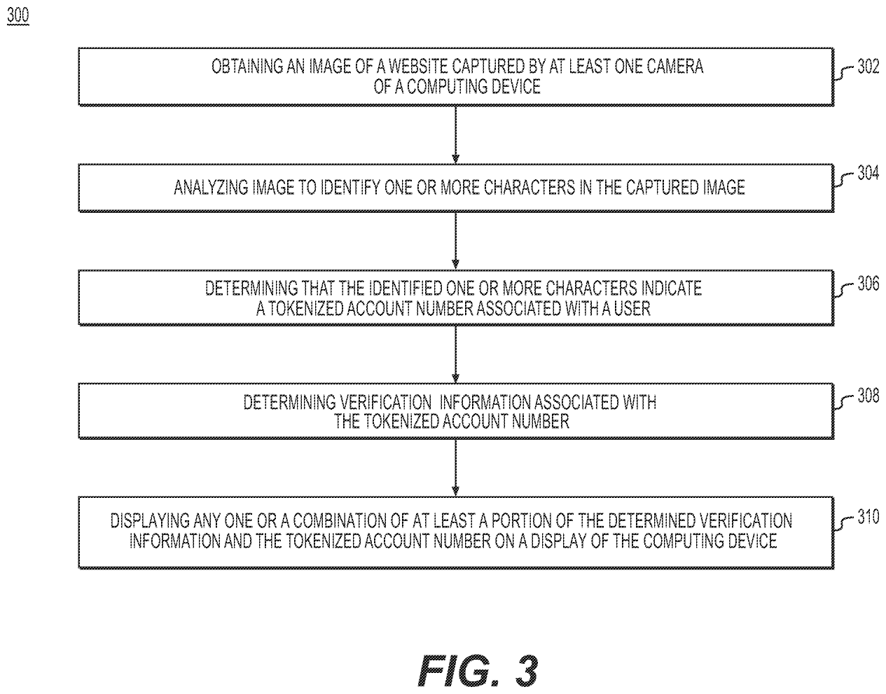

FIG. 3 depicts a flowchart of an exemplary process 300 of determining verification information according to one or more embodiments, and may be performed in the exemplary environment of FIG. 1. Process 300 may, in some embodiments, begin with step 302, in which an image of a merchant site of a merchant captured by at least one camera of a first computing device may be obtained. In some embodiments, the merchant site may be displayed on a display of a second computing device. In some embodiments the first computing device may comprise a virtual reality (VR) device. In step 304, one or more characters in the captured image may be identified. In step 306, the identified one or more characters may be determined to be indicating a virtual credit card number associated with a user. In some embodiments, the virtual credit card number comprises a tokenized credit card payment account number (PAN). In step 308, a CVV code associated with the virtual credit card number and an expiration date associated with the virtual credit card number may be determined as a result of determining that the captured image includes one or more characters indicative of the virtual credit card number. In some embodiments, determining the CVV code associated with the virtual credit card number and the expiration date associated with the virtual credit card number may include retrieving the CVV code and the expiration date from a secure database based on the virtual credit card number. In step 310, any one or a combination of at least a portion of the determined virtual credit card number, the determined CVV code associated with the virtual credit card number, and the determined expiration date associated with the virtual credit card number may be displayed on a display of the first computing device.

In some embodiments, process 300 may include a further step in which a gesture provided by the user using the first computing device may be detected. In such embodiments, upon detecting the gesture, process 300 may include a further step in which any one or a combination of at least the portion of the determined virtual credit card number, the determined CVV code associated with the virtual credit card number, and the determined expiration date associated with the virtual credit card number may be transmitted to the second computing device. In some embodiments, the second computing device may provide a connection to the merchant site.

In some embodiments, process 300 may include a further step in which the user may be authenticated via the first computing device based on identification information of the user. In some embodiments, authenticating the user via the first computing device based on identification information of the user may include: obtaining, via the first computing device, the identification information from the user; and comparing the obtained identification information with stored identification information. In some embodiments, the obtained identification information may include a biometric feature of the user, and the stored identification information may include a stored biometric feature of the user.

In some embodiments, displaying any one or a combination of at least the portion of the determined virtual credit card number, the determined CVV code associated with the virtual credit card number, and the determined expiration date associated with the virtual credit card number on the display of the first computing device may include: displaying any one or a combination of at least the portion of the determined virtual credit card number, the determined CVV code associated with the virtual credit card number, and the determined expiration date associated with the virtual credit card number in an augmented reality session. In some embodiments, displaying any one or a combination of at least the portion of the determined virtual credit card number, the determined CVV code associated with the virtual credit card number, and the determined expiration date associated with the virtual credit card number in the augmented reality session may include: receiving a current image of the merchant site captured by the at least one camera of the first computing device; determining a first portion of the current image associated with the at least the portion of the determined virtual credit card number; determining a second portion of the current image associated with the determined CVV code; determining a third portion of the current image associated with the determined expiration date; and overlaying the first portion of the current image with an image of the at least the portion of the determined virtual credit card number, the second portion of the current image with an image of the determined card verification value, and the third portion of the current image with an image of the determined expiration date.

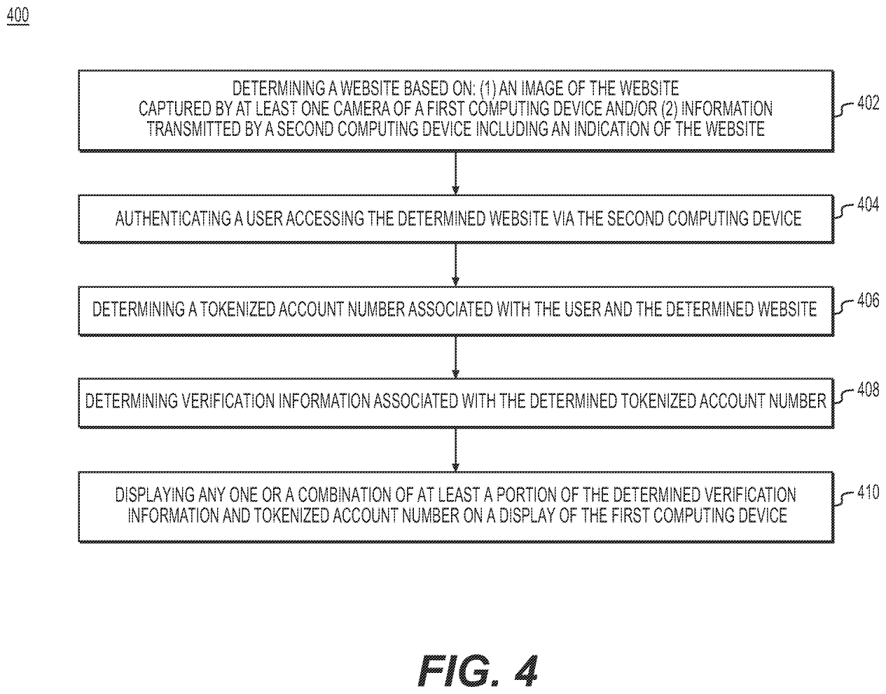

FIG. 4 depicts a flowchart of an exemplary process 400 of determining verification information according to one or more embodiments, and may be performed in the exemplary environment of FIG. 1. Process 400 may, in some embodiments, begin with step 402, in which a merchant site of a merchant may be determined based on: (1) an image of the merchant site captured by at least one camera of a first computing device and/or (2) information transmitted by a second computing device including an indication of the merchant site of the merchant. In step 404, a user accessing the determined merchant site via the second computing device may be authenticated. In step 406, a virtual credit card number associated with the user and the determined merchant site may be determined. In some embodiments, the virtual credit card number comprises a tokenized credit card payment account number (PAN). In step 408, a CVV code associated with the determined virtual credit card number and an expiration date associated with the determined virtual credit card number may be determined. In step 410, any one or a combination of at least a portion of the determined virtual credit card number, the determined CVV code associated with the virtual credit card number, and the determined expiration date associated with the virtual credit card number may be displayed on a display of the first computing device.

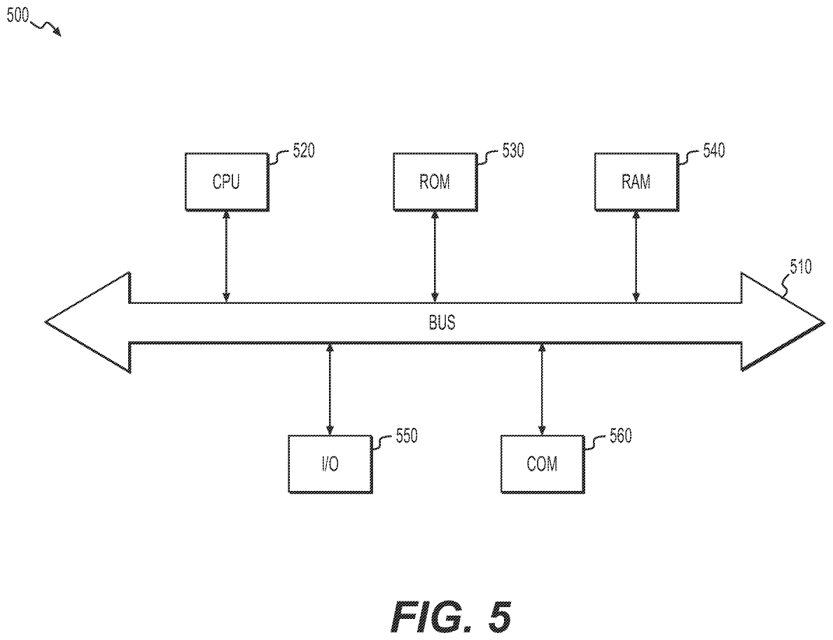

As shown in FIG. 5, device 500 (e.g., user device 104, access device 106, service providers 108, token vault 110, account institutions 112, and/or server systems 114) may include a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 may be connected to a data communication infrastructure 510, for example, a bus, message queue, network, or multi-core message-passing scheme.

Device 500 also may include a main memory 540, for example, random access memory (RAM), and also may include a secondary memory 530. Secondary memory 530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 530 may include other similar means for allowing computer programs or other instructions to be loaded into device 500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 500.

Device 500 also may include a communications interface (“COM”) 560. Communications interface 560 allows software and data to be transferred between device 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical, or other signals capable of being received by communications interface 560. These signals may be provided to communications interface 560 via a communications path of device 500, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 500 also may include input and output ports 550 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order (e.g., steps may be added, removed, or repeated), or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A method of determining verification information, comprising:
obtaining, via one or more processors, an image of a merchant site of a merchant captured by at least one camera of a first computing device, wherein the merchant site is displayed on a display of a second computing device;
identifying, via the one or more processors, one or more characters in the captured image;
determining, via the one or more processors, that the identified one or more characters indicate a virtual credit card number associated with a user, wherein the virtual credit card number comprises a tokenized credit card payment account number (PAN);
upon determining that the captured image includes one or more characters indicative of the virtual credit card number, determining, via the one or more processors, a card verification value associated with the virtual credit card number and an expiration date associated with the virtual credit card number; and
displaying, via the one or more processors, any one or a combination of at least a portion of the determined virtual credit card number, the determined card verification value associated with the virtual credit card number, and the determined expiration date associated with the virtual credit card number on a display of the first computing device.

2. The method of claim 1, wherein the first computing device comprises a virtual reality (VR) device.

3. The method of claim 1, further comprising:
detecting, via the one or more processors, a gesture provided by the user using the first computing device.

4. The method of claim 3, further comprising:
upon detecting the gesture, transmitting any one or a combination of at least the portion of the determined virtual credit card number, the determined card verification value associated with the virtual credit card number, and the determined expiration date associated with the virtual credit card number to the second computing device, wherein the second computing device provides a connection to the merchant site.

5. The method of claim 1, further comprising:
prior to determining the card verification value and the expiration date, authenticating, via the one or more processors, the user via the first computing device based on identification information of the user.

6. The method of claim 5, wherein authenticating the user via the first computing device based on identification information of the user comprises:
obtaining, via the first computing device, the identification information from the user; and
comparing the obtained identification information with stored identification information.

7. The method of claim 6, wherein the obtained identification information comprises a biometric feature of the user, and wherein the stored identification information comprises a stored biometric feature of the user.

8. The method of claim 1, wherein the displaying any one or a combination of at least the portion of the determined virtual credit card number, the determined card verification value associated with the virtual credit card number, and the determined expiration date associated with the virtual credit card number on the display of the first computing device comprises:
displaying any one or a combination of at least the portion of the determined virtual credit card number, the determined card verification value associated with the virtual credit card number, and the determined expiration date associated with the virtual credit card number in an augmented reality session.

9. The method of claim 8, wherein the displaying any one or a combination of at least the portion of the determined virtual credit card number, the determined card verification value associated with the virtual credit card number, and the determined expiration date associated with the virtual credit card number in the augmented reality session comprises:
receiving a current image of the merchant site captured by the at least one camera of the first computing device;
determining a first portion of the current image associated with the at least the portion of the determined virtual credit card number;
determining a second portion of the current image associated with the determined card verification value;
determining a third portion of the current image associated with the determined expiration date; and
overlaying the first portion of the current image with an image of the at least the portion of the determined virtual credit card number, the second portion of the current image with an image of the determined card verification value, and the third portion of the current image with an image of the determined expiration date.

10. The method of claim 1, wherein the determining the card verification value associated with the virtual credit card number and the expiration date associated with the virtual credit card number comprises:
retrieving the card verification value and the expiration date from a secure database based on the virtual credit card number.

11. A first computing device for determining verification information, comprising:
a memory;
at least one camera;
a display; and
one or more processors, the one or more processors configured to:
obtain an image of a merchant site of a merchant captured by the at least one camera, wherein the merchant site is displayed on a display of a second computing device;
identify one or more characters in the captured image;
determine that the identified one or more characters indicate a virtual credit card number associated with a user, wherein the virtual credit card number comprises a tokenized credit card payment account number (PAN);
upon determining that the captured image includes one or more characters indicative of the virtual credit card number, determine a card verification value associated with the virtual credit card number and an expiration date associated with the virtual credit card number; and
display any one or a combination of at least a portion of the determined virtual credit card number, the determined card verification value associated with the virtual credit card number, and the determined expiration date associated with the virtual credit card number on the display.

12. The first computing device of claim 11, wherein the first computing device comprises a virtual reality (VR) device.

13. The first computing device of claim 11, wherein the one or more processors are further configured to:
detect a gesture provided by the user using the first computing device.

14. The first computing device of claim 13, wherein the one or more processors are further configured to:
upon detecting the gesture, transmit any one or a combination of at least the portion of the determined virtual credit card number, the determined card verification value associated with the virtual credit card number, and the determined expiration date associated with the virtual credit card number to the second computing device, wherein the second computing device provides a connection to the merchant site.

15. The first computing device of claim 11, wherein the one or more processors are further configured to:
prior to determining the card verification value and the expiration date, authenticate the user via the first computing device based on identification information of the user.

16. The first computing device of claim 15, wherein the authenticating the user via the first computing device based on identification information of the user comprises:
obtaining the identification information from the user; and
comparing the obtained identification information with stored identification information.

17. The first computing device of claim 16, wherein the obtained identification information comprises a biometric feature of the user, and wherein the stored identification information comprises a stored biometric feature of the user.

18. The first computing device of claim 11, wherein the displaying any one or a combination of at least the portion of the determined virtual credit card number, the determined card verification value associated with the virtual credit card number, and the determined expiration date associated with the virtual credit card number on the display of the first computing device comprises:
displaying any one or a combination of at least the portion of the determined virtual credit card number, the determined card verification value associated with the virtual credit card number, and the determined expiration date associated with the virtual credit card number in an augmented reality session.

19. The first computing device of claim 11, wherein determining the card verification value associated with the virtual credit card number and the expiration date associated with the virtual credit card number comprises:
retrieving the card verification value and the expiration date from a secure database based on the virtual credit card number.

20. A method of determining verification information, comprising:
determining, via one or more processors, a merchant site of a merchant based on: (1) an image of the merchant site captured by at least one camera of a first computing device and/or (2) information transmitted by a second computing device including an indication of the merchant site of the merchant;
authenticating, via the one or more processors, a user accessing the determined merchant site via the second computing device;
determining, via the one or more processors, a virtual credit card number associated with the user and the determined merchant site, wherein the virtual credit card number comprises a tokenized credit card payment account number (PAN);
determining, via the one or more processors, a card verification value associated with the determined virtual credit card number and an expiration date associated with the determined virtual credit card number; and
displaying, via the one or more processors, any one or a combination of at least a portion of the determined virtual credit card number, the determined card verification value associated with the virtual credit card number, and the determined expiration date associated with the virtual credit card number on a display of the first computing device.
